(19) United States
(12) Patent Application Publication
(10) Pub. No.: US 2009/0282827 A1
(43) Pub. Date: Nov. 19, 2009

(54) Speed booster gas saving device

(76) Inventor: Teodorico Julaton Badua, Bacnotan (PH)

Correspondence Address: Marites Badua, 350 E. Whidbey Ave. #2, Oak Harbor, WA, 98277, US

(21) Appl. No.: 12/322,311

(22) Filed: Feb. 2, 2009

(30) Foreign Application Priority Data
Mar. 4, 2008 (PH) 1-2008-000068

(51) Int. Cl. F02G 5/02

(52) U.S. Cl. 60/614

(57) ABSTRACT

In the present invention disclosed an speed booster gas saving device that recovers exhaust energy of internal combustion engine, wherein the exhaust force and the heat energy of exhaust gases that is wasted is utilized, to superheat a device to transform water instantly into steam energy upon injected inside in addition to the exhaust force to drive a rotor blades connected to the propeller shaft or to the differential gear, to increase the driving torque, power and speed of a moving vehicle in addition to the engine power to reduce fuel burning and emission of exhaust in the environment.

### FIELD OF THE INVENTION

The present invention relate to an speed booster gas saving device, that recovers exhaust energy of internal combustion engine to save fuel, wherein the exhaust force and the heat energy of exhaust gases that is wasted, is utilized to superheat a device to transform water instantly into steam energy upon injected inside, in addition to the exhaust force to drive a rotor blades connected to the propeller shaft or to the differential gear to increase the driving torque, power and speed of a moving vehicle, in addition to the engine power to gain more mileage with less fuel burning and emission of exhaust in the environment.

The technology of the invention can also applies in the industrial sector especially in power generating plant and airline facilities to utilize the heat energy of exhaust gases of the turbine engine, to transform water instantly into steam energy upon injected inside in addition to the exhaust thrust of the turbine engine, to increase generating capacity or speed of an airplane. Carrying water on board in an airplane is not a problem, though waste water can be injected inside the superheated chamber to produce steam energy in addition to the exhaust thrust.

### BACKGROUND OF THE INVENTION

In the internal combustion engine, the exhaust gas flowing out from the engine is a by-product of combustion after power stroke that has a remaining energy, the pressure, and heat, that is wasted as it flows out in the atmosphere. Although the exhaust pressure (force) is used to drive a turbo charger, the purpose is to increase the engine power to carry a heavier load by increasing the volume of air inside the combustion chamber for a higher compression to introduce more fuel during combustion to produce more power, but the exhaust energy remain as waste as it flows out and becomes more and greater in the processed.

Conservation of energy is the core concept of the invention, wherein the exhaust energy wasted is converted into mechanical energy in addition to the engine torque to increase speed of a moving vehicle to achieve a greater distance with less fuel burning and emission of exhaust of internal combustion engine to reduce air pollution in the environment.

### SUMMARY OF THE INVENTION

The present invention relate to an speed booster gas saving device more particularly to the method of converting exhaust energy into mechanical force to save fuel of internal combustion engine, wherein the exhaust force and the heat energy of exhaust gases wasted is utilized to superheat a device, to transform water instantly into steam energy upon injected inside in addition to the exhaust force to drive a rotor blades connected to the propeller shaft, or to connect the rotor blades to a differential gear to drive the rear wheels of a front wheel driven car in addition to the engine force to increase the driving torque, power and speed of a moving vehicle to save fuel consumption and emission of exhaust in the environment.

The method is consist of enlarging a portion of the exhaust pipe connected directly in the exhaust manifold of an engine, to encased inside a tubular stainless steel steam chamber to be superheated by the flowing hot gases that bears a temperature of 650° F. to 950° F. to transform water instantly into steam energy upon injected inside, by a water feed pump in a nozzle jet inserted horizontally on the steam chamber that taperedly closed at the upper end, having an opening on the opposing end below for the steam generated to discharge out, in addition to the exhaust force flowing on the exhaust pipe leading to the driven rotor blades connected to the propeller shaft inside a housing enclosure in addition to the engine torque to increase speed of a moving vehicle. With the rotating motion of the rotor blades, the exhaust gases flows continuously out in the housing enclosure exhaust outlet connecting the exhaust pipe into the atmosphere.

To adapt the rotor blades in the propeller shaft, the cross-joint yoke is modified by replacing the yoke of the transmission gear sleeve coupling with a connecting flange, and securely fastened to the transmission gear power output shaft with an screw bolt on the shaft center end for the rotor blades a fixed axis when adapted, with a four connecting bolts together with the velocity joint in replacement of the cross-joint to drive the propeller shaft.

The rotor blades housing enclosure is firmly attached to the transmission gear housing end with supporting bars connected to each other, to secure the rotor blades housing body with a side cover to enclosed the rotor blades inside. On the inlet exhaust pipe connected on the housing enclosure exhaust inlet, a heat expansion joint is connected to protect the driven blades from thermal expansion of the exhaust pipe, and also a by-pass exhaust valve is connected across the housing enclosure exhaust inlet pipe and exhaust outlet pipe that open in time the vehicle stops on traffic lights or somewhere, and when the vehicle is shifted in reverse gear, to allow the exhaust to flow freely to prevent the engine from suffocation. The speed booster gas saving device is provided with a water supply and control system. From the tank, a water supply tube is connected to the water feed pump suction side. The pump is electrically operated on and off through a control switch mechanically actuated through the engine accelerating mechanism, to control the flow of water into the water nozzle jet inserted horizontally inside the water transforming device, to minimize using water especially when the vehicle is running down hills that the engine power is not much needed, to save water to carry less volume on board.

This invention does not affect nor bear damage to the engine, since the technology of the invention is applied outside the engine body, on the exhaust discharge line to recover the exhaust energy wasted to convert into mechanical energy in addition to the engine torque to save fuel of internal combustion engine and to reduce exhaust emission in the environment.

### BRIEF DESCRIPTION OF THE DRAWING

FIG. 1 is an schematic partially cut-out view of the enlarged exhaust pipe representing the water transforming chamber inside and the driven rotor blades in an open enclosure to illustrate their relationship and function in accordance to the principle of the invention.

FIG. 2 is a cross sectional view of the driven rotor blades inside in a housing enclosure to illustrate how it is adapted in the vehicle in relation in the recovery of exhaust energy.

FIG. 3 is a cross sectional view of the water supply and control system of the speed booster gas saving device.

### DETAILED DESCRIPTION OF THE INVENTION

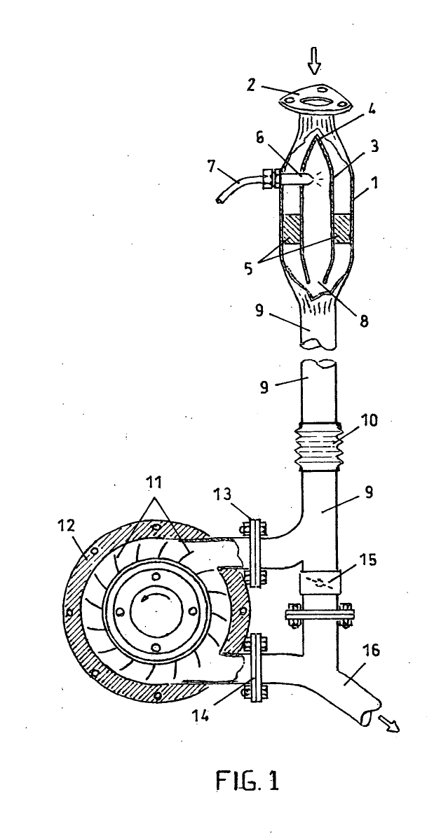

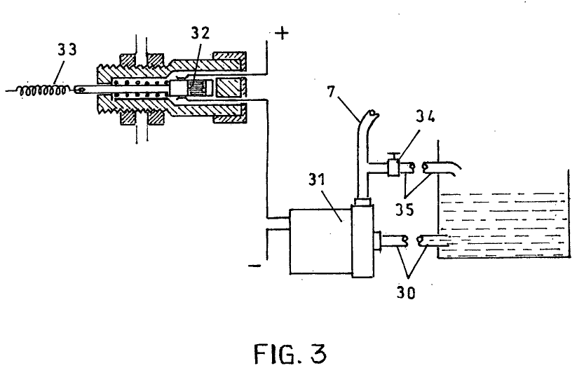

In drawing FIG. 1, the arrow represent the direction of exhaust flow from the engine to the enlarge portion of the exhaust pipe (1) to be connected in flange (2) in the exhaust manifold of an engine is seen partially cut-out to present the water transforming device tubular stainless steel steam chamber body (3) taperedly close at the upper end (4) with support plate (5) inside. The tapered end is to allow the exhaust gases to flow smoothly where the water nozzle jet (6) is inserted horizontally a little below on its side, with a water delivery tube (7) connected from a water feed pump (31) FIG. 3. On the opposing end below of the steam chamber body is slightly reduced in size for steam discharge opening (8) in which the enlarged portion of the exhaust pipe lower end is gradually reduced to the exhaust pipe (9) original size to placed a heat expansion joint (10) to protect the driven rotor blades (11) inside the housing enclosure (12) from thermal expansion of the exhaust pipe connecting housing enclosure exhaust inlet (13) and exhaust outlet (14) in flanges. The device is also provided with exhaust by-pass valve (15) connected across the housing enclosure exhaust pipe inlet (9) and exhaust pipe outlet (16) to allow a continuous flow of exhaust gases to prevent the engine from suffocation in time that the vehicle stop on traffic lights or somewhere and when the vehicle is shifted in reverse gear.

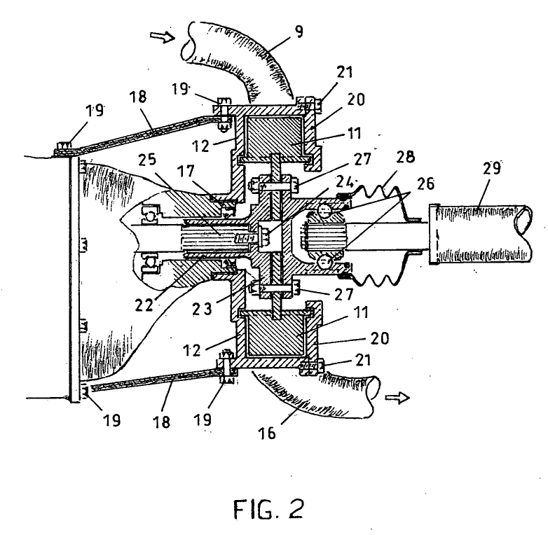

In drawing FIG. 2, is seen that the rotor blades (11) is inside in the housing enclosure (12) that firmly attached on the transmission gear housing end (17) with supporting bars (18) connected to each other in screw bolts (19), in the opposite side is the housing enclosure side cover (20) with a fastening bolts (21) around. Inside, said rotor blades is adapted in a modified cross joint yoke by replacing the yoke in the transmission gear sleeve coupling (22) with a connecting flange (23) and securely fastened with screw bolt (24) on the transmission gear power output shaft (25) center end, to adapt the rotor blades and the velocity ball joint (26) together, with a connecting bolts (27) for the rotor blades a fixed axis during operation. Said velocity ball joint with a flexible dust guard (28) is in placed of the cross joint to drive the propeller shaft (29).

In FIG. 3, is seen from the water supply tank, a water suction tube (30) is connected on the water feed pump (31) suction side. The pump is electrically operated on and off through a control switch (32) mechanically actuated through an spring link (33) connected in the engine accelerating mechanism to control the flow of water into the water nozzle jet (6) inside the water transforming chamber through the water delivery tube (7) with a pressure control valve (34) connected on the water return tube (35) to the water supply tank. The on and off water control system is to save water carried on board especially when the vehicle is running down hills that the engine power is not much needed to carry less volume onboard.

I claim:

1. An speed booster gas saving device that recovers the energy of exhaust gases flowing from the engine wherein the exhaust force and the heat energy wasted is utilize, to superheat a device to transform water instantly into steam energy upon injected inside in addition to the exhaust force to drive a rotor blades connected to the propeller shaft, or to the differential gear to increase the driving force, power and speed of a moving vehicle comprising of,
enlarging a portion of the exhaust pipe connected directly below in the exhaust manifold of an engine, to encased inside a tubular stainless steel chamber taperedly closed at the upper end where a water nozzle jet is inserted horizontally a little below on its side, with a support plate and an opening on the opposing end below that slightly reduced in size for the steam generated to discharge out in addition to the exhaust force flowing on the exhaust pipe to drive,

2. The speed booster gas saving device rotor blades connected to the propeller shaft in accordance with claim 1, consist of,
modifying the cross joint yoke of the transmission gear sleeve coupling to replace the yoke with a connecting flange to adapt said rotor blades and velocity joint with a four connecting bolts together, to drive the propeller shaft in placed of the cross joint, and said modified cross joint yoke is securely fastened to the transmission gear power output shaft with screw bolt on the shaft center end,

3. The speed booster gas saving device driven rotor blades, in accordance with claim 1, and claim 2, has a housing enclosure that firmly attached to the transmission gear housing end with supporting bars to secure the housing body, having an exhaust inlet and exhaust outlet and a side cover to enclosed said rotor blade inside, and on the exhaust pipe connecting said exhaust inlet housing enclosure a heat expansion joint is connected, and also an exhaust by-pass valve connected across said housing enclosure to by-pass the exhaust flow to protect the engine,

4. The speed booster gas saving device in accordance with claim 1, wherein the injected water is delivered by a water feed pump electrically operated on and off through a control switch, mechanically actuated through a connected spring link to the engine accelerating mechanism to save water, especially when the vehicle is running down hills that the engine power is not much needed to carry less volume of water on board.

5. The speed booster gas saving device in accordance with claim 2, and 3, wherein the driven rotor blades complete assembly can be connected to a differential gear to drive the rear wheels of a front wheel driven car in addition to the engine force to increase the speed momentum of a vehicle in motion.
